(19) United States
(12) Patent Application Publication
(10) Pub. No.: US 2024/0261964 A1
(43) Pub. Date: Aug. 8, 2024

(54) METHOD AND COMPUTER PROGRAM PRODUCT FOR CONTROLLING A ROBOT

(71) Applicant: DEUTSCHES ZENTRUM FÜR LUFT- UND RAUMFAHRT E.V., Bonn (DE)

(72) Inventors: Johannes ENGLSBERGER, Wessling (EC); Gianluca GAROFALO, Wessling (DE); George Adrian MESESAN, Wessling (DE)

(21) Appl. No.: 18/008,760

(22) PCT Filed: Jun. 10, 2021
(86) PCT No.: PCT/EP2021/065699

§ 371 Date: Dec. 7, 2022

(30) Foreign Application Priority Data
Jun. 10, 2020 (DE) 10 2020 115 517.4

(51) Int. Cl. B25J 9/16

(52) U.S. Cl. CPC B25J 9/1643; B25J 9/1607

(57) ABSTRACT

A method for controlling a kinematically redundant robot (100) in order to fulfill multiple tasks. At least one passivity-based first controller module (102) is used, at least one task target description and at least one associated task mapping are computed for the at least one first controller module (102), at least one weighting is computed for the tasks, and the at least one first controller module (102) is integrated into an overall controller (104), using the at least one weighting. Moreover, the invention relates to a computer program product that includes commands which, when the program is executed with the aid of at least one processor, prompt the processor to carry out such a method.

The present invention relates to a method for controlling a kinematically redundant robot in order to fulfill multiple tasks. Moreover, the present invention relates to a computer program product for carrying out such a method.

The simultaneous control of multiple tasks represents an important research topic in the field of robotic control. While earlier studies considered the simpler case of controlling a single task and the corresponding nullspace, i.e., the remaining degrees of freedom of the robot, for kinematically redundant robots, several established methods presently exist that allow handling of multiple tasks with and without priorities. The literature makes a distinction between studies that solve the task coordination problem initially on a kinematic level, and studies that handle the control problem directly on the dynamic level. A further important classification option is the division into methods that require strict task priorities via hierarchical controllers, and other methods that apply a soft prioritization via task weighting.

At the kinematic level, hierarchical controllers that are based on nullspace projections and that guarantee a strict task hierarchy have been proposed in the publications by Y. Nakamura, H. Hanafusa, and T. Yoshi Kawa, Task-priority based redundancy control of robot manipulators, The International Journal of Robotics Research, 6(2): 3-15, 1987, doi: 10.1177/027836498700600201; and G. Antonelli, Stability analysis for prioritized closed-loop inverse kinematic algorithms for redundant robotic systems, IEEE Transactions on Robotics, 25(5):985-994, 2009. To address the problem of possible task singularities, a singularity-robust inverse kinematics method has been proposed in the publication by F. Kanehiro, H. Hirukawa, and S. Kajita, Openhrp: Open architecture humanoid robotics platform, The International Journal of Robotics Research, 23(2): 155-165, 2004, doi: 10.1177/0278364904041324. However, due to these singularity-robust inverse kinematics, the strict task hierarchy is lost, since ultimately a weighting is thus generated between the individual tasks.

Other methods handle multiple tasks simultaneously on the dynamic level. The “operational space” method has been further developed to enable the control of humanoid robots. In this regard, reference is made to the publications by L. Sentis and O. Khatib, Synthesis of whole-body behaviors through hierarchical control of behavioral primitives, International Journal of Humanoid Robotics, 2(4): 505-518, 2005; and L. Sentis, J. Park, and O. Khatib, Compliant control of multicontact and center-of-mass behaviors in humanoid robots, IEEE Transactions on Robotics, 26(3):483-501, 2010. Other methods based on “inverse dynamics” (ID) use hierarchical quadratic programs (QPs). In this regard, reference is made to the publications by J. Peters, M. Mistry, F. Udwadia, J. Nakanishi, and S. Schaal, A unifying framework for robot control with redundant DOFs, Autonomous Robots, 24:1-12, 2008, doi: 10.1007/s10514-007-9051-x; Adrien Escande, Nicolas Mansard, and Pierre-Brice Wieber, Hierarchical quadratic programming: Fast online humanoid-robot motion generation, The International Journal of Robotics Research, 33(7):1006-1028, 2014, doi: 10.1177/0278364914521306; and K. Bouyarmane and A. Kheddar, On weight-prioritized multitask control of humanoid robots, IEEE Transactions on Automatic Control, 63(6): 1632-1647, June 2018, ISSN 2334-3303, doi: 10.1109/TAC.2017.2752085. Most of the stated methods are aimed at a strict task decoupling. For example, this ensures, at least in theory, that different tasks do not mutually influence one another, and likewise that the particular transient response of individual tasks after disturbances is completely independent of other task coordinates.

The method provided here is inspired by the family of inverse dynamics-based tracking controllers, which seek a soft compromise between a series of tasks by using a single weighted quadratic program (QP). In this regard, reference is made to the publications by M. A. Hopkins, D. W. Hong, and A. Leonessa, Compliant locomotion using whole-body control and divergent component of motion tracking, IEEE Int. Conf. on Robotics and Automation (ICRA), pages 5726-5733, May 2015, doi: 10.1109/ICRA.2015.7140001; T. Koolen, S. Bertrand, G. Thomas, T. de Boer, T. Wu, J. Smith, J. Englsberger, and J. Pratt, Design of a momentum-based control framework and application to the humanoid robot atlas, International Journal of Humanoid Robotics, 13(01):1650007, 2016, doi: 10.1142/S0219843616500079; and J. Englsberger, G. Mesesan, A. Werner, and C. Ott, Torque-based dynamic walking—a long way from simulation to experiment, IEEE Int. Conf. on Robotics and Automation (ICRA), pages 440-447, 2018. Such controllers are very easy to implement, and are characterized by their high level of flexibility. However, in comparison to passivity-based methods according to the publications by B. Paden and B. Riedle, A positive-real modification of a class of nonlinear controllers for robot manipulators, 1988 American Control Conference, pages 1782-1785, June 1988, doi: 10.23919/ACC.1988.4790015; A. Dietrich, Whole-body Impedance Control of Wheeled Humanoid Robots, Volume 116, Springer International Publishing, 2016, ISBN 978-3-319-40557-5; B. Henze, M. A. Roa, and Ch. Ott, Passivity-based whole-body balancing for torque-controlled humanoid robots in multi-contact scenarios, The International Journal of Robotics Research, 35(12):1522-1543, 2016, doi: 10.1177/0278364916653815; G. Mesesan, J. Englsberger, G. Garofalo, C. Ott, and A. Albu-Schäffer, 15:47 6/10/2020, Dynamic walking on compliant and uneven terrain using DCM and passivity-based whole-body control, IEEE-RAS 19th Int. Conf. on Humanoid Robots (Humanoids), pages 25-32, 2019; and A. Dietrich and C. Ott, Hierarchical impedance-based tracking control of kinematically redundant robots, IEEE Transactions on Robotics, 36(1):204-221, 2020, ISSN 1941-0468, doi: 10.1109/TRO.2019.2945876, inverse dynamics-based controllers are less robust with regard to model errors and contact uncertainties, so that in actual use, problems such as vibrations, for example, occur, which must then in turn be handled with the aid of heuristic methods.

Furthermore, the provided method is inspired by the weighting-based multitasking controller from the publication by K. Bouyarmane and A. Kheddar, On weight-prioritized multitask control of humanoid robots, IEEE Transactions on Automatic Control, 63(6):1632-1647, June 2018, ISSN 2334-3303, doi: 10.1109/TAC.2017.2752085, and also by the strictly hierarchical passivity-based controller from the publication by A. Dietrich and C. Ott, Hierarchical impedance-based tracking control of kinematically redundant robots, IEEE Transactions on Robotics, 36(1):204-221, 2020, ISSN 1941-0468, doi: 10.1109/TRO.2019.2945876. Similarly as in the publication by K. Bouyarmane and A. Kheddar, On weight-prioritized multitask control of humanoid robots, IEEE Transactions on Automatic Control, 63(6): 1632-1647, June 2018, ISSN 2334-3303, doi: 10.1109/TAC.2017.2752085, the provided method uses a quadratic program (QP) to combine the control objectives of the individual tasks or to weight them against one another. However, in the publication by K. Bouyarmane and A. Kheddar, On weight-prioritized multitask control of humanoid robots, IEEE Transactions on Automatic Control, 63(6):1632-1647, June 2018, ISSN 2334-3303, doi: 10.1109/TAC.2017.2752085, each of the controllers associated with the individual tasks is computed based on inverse dynamics, a unit matrix being used as desired inertia, which corresponds to feedback linearization. In contrast, the provided method computes the controllers associated with the individual tasks, based on the concept of passivity, and uses the natural inertia of the robot, so that a behavior similar to that of a PD+ controller is achieved. In contrast to the method known from the publication by A. Dietrich and C. Ott, Hierarchical impedance-based tracking control of kinematically redundant robots, IEEE Transactions on Robotics, 36(1):204-221, 2020, ISSN 1941-0468, doi: 10.1109/TRO.2019.2945876, which is likewise based on the use of the natural inertia for the control approach, the provided method uses a weighted QP formulation, i.e., a soft prioritization, thus allowing combination of an arbitrary number of various tasks, the method also resulting in less aggressive behavior in certain situations, for example when a task singularity occurs.

The object underlying the present invention is to improve a method mentioned at the outset. Moreover, the object underlying the present invention is to provide a computer program product mentioned at the outset.

The object is achieved using a method having the features of claim 1. Moreover, the object is achieved using a computer program product having the features of claim 15. Advantageous embodiments and/or refinements are the subject matter of the subclaims.

The method may be used for closed-loop control of the robot. The method may be used, for example, in service robotics, in medical robotics, in Industry 4.0, and in the area of robotic assistance for astronauts. In principle, the method may be used anywhere that force/torque-controlled robots with kinematic redundancy may be employed, and thus where high precision as well as a flexible human-robot interaction or surroundings-robot-interaction are desired.

A kinematically redundant robot may have multiple degrees of freedom, in such a way that multiple tasks may be implemented at the same time. The tasks may be independent of one another. The tasks may be implementable, at least in part, at the same time. The robot may be force-controlled and/or torque-controlled. The passivity-based controller module may be an impedance-based controller module. In the present context, the term “passivity” is used in particular for delimiting an “activity” in which an undesirable energy increase occurs in the system.

In the present context, the phrase “task target description” describes in particular a variable that results from a combination of terms, corresponding to the actual objective of the particular task, with appropriate pilot control or compensation terms. The corresponding objective of the task may be made up, for example, of a nominal tracking of a reference trajectory and/or also made up, advantageously at the same time, of the flexible impedance behavior, for example in the case of an interaction with the surroundings, an object, or a human. The pilot control and/or compensation terms may completely or partially compensate for gravitation effects as well as Coriolis and/or centrifugal effects, for example, in order to generate the actual desired behavior and/or the actual desired dynamics.

In the present context, the phrase “task mapping” describes in particular a variable that establishes the relationship between the given manipulated variables and/or control inputs and the particular above-mentioned task target description. The manipulated variables and/or control inputs may be made up, for example, of settable torques in the robot joints, and in the case of free-floating robots such as humanoid robots, for example, also of contact forces which under certain conditions result from the constraints between the joint torques and given end effector accelerations, for example robot foot accelerations.

The at least one task target description and the at least one associated task mapping may be computed in such a way that a nominal behavior of the at least one first controller module corresponds to the behavior of a mass-spring-damper system.

The at least one task target description and the at least one associated task may be computed based on a natural robot inertia.

The at least one task target description and the at least one associated task mapping may be computed in such a way that task-specific Coriolis and centrifugal effects remain unchanged, while all other Coriolis and centrifugal effects are compensated for.

The at least one task target description may be computed as a task vector. The task vector may indicate a force, a force direction, a torque, and/or a torque direction. Desired task force f_{k,des} in equation (17) represents such a task vector. In addition, the individual task vectors may advantageously be combined to form a combined task vector. “Combination of all desired task forces” f_{des} described in equation (21) represents an example of such a combined task vector.

The at least one associated task mapping may be computed as a task mapping matrix. The task mapping matrix may also be referred to as a mapping matrix T or a mapping matrix U. Matrix Tₖ described in equation (12), which may be referred to as a “dynamically consistent pseudoinverse” of the transposition of task Jacobian matrix Jₖ, represents an example of such a task mapping matrix. The individual task mapping matrices may also advantageously be combined into a unified task mapping matrix T, as described in equation (22).

At least one further controller module may be integrated into the overall controller. At least one further controller module formulated as a constraint may be integrated into the overall controller.

The at least one first controller module and/or the at least one further controller module may be weighted. A weighting matrix may be used for the weighting. The weighting matrix may also be referred to as a weighting matrix W.

The at least one first controller module and/or the at least one further controller module may be weighted in such a way that the overall controller has an at least approximately passive behavior, even for an overdetermined control problem.

The at least one first controller module and/or the at least one further controller module may be optimized with the aid of at least one pseudoinverse and/or at least one inverse.

The at least one first controller module and/or the at least one further controller module may be optimized with the aid of at least one optimization variable. The at least one first controller module and/or the at least one further controller module may be quadratically optimized. The quadratic optimization may be implemented by a single instance or by multiple instances.

At least one of the controller modules may be designed as a tracking controller. At least one of the controller modules may be designed as a regulation controller. A separate controller module may be assigned to each controllable degree of freedom.

The computer program product may be present on a computer-readable memory medium, on a computer-readable data medium, or as a data medium signal.

The method may include the following steps: a) computing the desired task forces and the associated task mapping matrices for all passive tracking controller modules, the nominal behavior of the passive tracking controller modules corresponding to that of mass-spring-damper systems, in addition the natural inertia of the robot being maintained, and furthermore the task-specific Coriolis and centrifugal effects remaining unchanged, while all other Coriolis and centrifugal effects are compensated for; b) computing the particular passivity-guaranteeing or passivity-facilitating weighting matrices for all tasks, c) integrating and combining the individual passive tracking controller modules by optimization to form an overall controller, using the particular passivity-guaranteeing or passivity-facilitating weighting matrices.

In addition to the passive tracking controller modules, other controllers or controller modules may be integrated in method step c). In method step c), in addition to the weighted tasks, one or multiple tasks may also be formulated as a constraint and correspondingly integrated into the overall controller via the optimization. A pseudoinverse may be used in method step c) for the optimization. In method step c), the optimization may be based on the concept of quadratic optimization or quadratic programming (QP).

The present invention may relate to a controller module for controlling torque-based robots. The controller module may include a task mapping matrix and a desired task vector, it being possible for a nominal behavior of the controller module to correspond to a mass-spring-damper system.

The corresponding mass or inertia of the natural mass or inertia of the robot, optionally projected into the corresponding task space, may thus correspond to an impedance behavior, referred to as compliance behavior, which is based on the natural robot mass or the natural robot inertia, and which thus dispenses with the so-called inertia shaping.

The task-specific Coriolis and centrifugal effects may remain unchanged, while all other Coriolis and centrifugal effects are compensated for, as the result of which the passivity of the controller module may be achieved.

The controller module may be designed as a tracking controller. The controller module may be designed as a regulation controller, and a pilot control may thus be dispensed with.

An arbitrary number of such controller modules may be combined to form an overall controller. An arbitrary number of such controller modules and an arbitrary number of other controllers or controller modules may be combined to form an overall controller.

The present invention may relate to such an overall controller, it being possible for a soft prioritization to take place with the aid of weighting of the tasks, corresponding to the controller modules.

The weighting of the tasks corresponding to the controller modules may be designed in such a way that the passivity of the overall controller is guaranteed, or a behavior of the overall controller is generated which best approaches a passive behavior, even if the objectives of the individual tasks conflict and an overdetermined control problem is thus present.

In addition, a task or multiple tasks may be formulated as a hard constraint, while all other tasks are based on such controller modules and are taken into account by a soft weighting or are integrated into the overall controller.

For solving the control problem, a quadratic optimization may be used, which may be implemented by a single instance for the quadratic optimization, or also by multiple instances for the quadratic optimization.

One or multiple pseudoinverses or inverses may be used to solve the control problem.

A dedicated controller module may be assigned to each controllable degree of freedom, as the result of which a maximum granularity or the maximum possible decoupling of the individual task controllers is achieved.

In summary and stated in other words, the present invention thus results, among other things, in a modular passive tracking controller for force-/torque-controlled robots.

The controller according to the present invention allows a robust control of redundant robotic systems which is precise and at the same time flexible. This is achieved by using passivity-based controller modules, which may be combined to form an overall controller with the aid of various optimization methods (depending on the problem in question). By use of a particular weighting of the various tasks, the passivity of the overall controller, once again depending on the problem in question, is either guaranteed or at least facilitated. This particular weighting is based on using the particular inverted task inertia matrix, multiplied by a scalar task weighting number, as a weight for the individual tasks. Controller design and analysis are based on the concept of passivity or on Lyapunov theory, thus achieving the high level of robustness of the control.

The present method has proven to be very flexibly usable, with robustness against singularities and robustness with regard to modeling errors and measuring noise (changing the controller structure online is easily possible, as well as combination with other controller methods), and also very robust upon contact with the surroundings. The tuning effort during actual experiments or for actual applications is very low. An arbitrary number of tasks may be combined with one another; each task contributes to the overall result, corresponding to its weighting.

The present method thus combines the most important advantages of all methods described in the related art for the control of redundant, torque-controlled robotic systems, while avoiding all disadvantages.

The present method covers virtually the entire spectrum between inverse dynamics-based controllers and the very robust so-called PD+-based controllers. The granularity of the desired decoupling or the modularity of the individual subcontrollers is freely selectable.

The technical field addressed in particular by the present invention is the control of redundant, torque-controlled robotic systems. Solving multitasking tasks represents a difficult problem, in particular with regard to stability and passivity of the overall controller, precise tracking of desired reference trajectories, robustness with regard to modeling accuracy and sensor noise, robustness against singularities, flexibility in implementation and combinability of different subcontrollers, and contact stability.

The related art encompasses essentially two different methods which partially solve this problem: inverse dynamics-based methods on the one hand, and passivity- or impedance-based methods on the other hand. Both solution approaches contained in the related art have certain disadvantages which thus far have not been overcome:

Inverse dynamics are not passive, so that serious stability problems may occur in actual application scenarios. In addition, inverse dynamics are not robust with regard to modeling accuracy and sensor noise, and are also susceptible to singularities. Furthermore, the contact stability cannot always be ensured using inverse dynamics-based control methods.

The passivity- or impedance-based methods known from the related art generally have either poor tracking of the desired reference trajectories or a susceptibility to singularities. In addition, the corresponding controller implementation is generally inflexible, and a combination of different subcontrollers or controller types is not provided.

The present invention is based on a method for controlling redundant, torque-controlled robotic systems in which passive or impedance-based tracking controller modules are combined with one another via optimization. By use of a particular type of weighting, it is ensured that due to the combination/synthesis of the individual controller modules, the passivity of the overall system is not lost, or that the corresponding combination/synthesis does not result in an activity, i.e., a corresponding undesirable increase in the energy in the system. In this way, all above-mentioned advantages are achieved and the corresponding disadvantages are avoided. In particular, the method underlying the present invention ensures the stability and passivity of the overall system, or facilitates the latter in the case that stabilization or passivation of the overall system is technically impossible, achieves precise tracking of the desired reference trajectories, provided that they are not inconsistent and are thus technically achievable, is robust with respect to singularities, modeling accuracy, and sensor noise, is characterized by good contact stability, and allows a flexible implementation in which, among other things, different types of controllers may be combined with one another. The method underlying the present invention thus completely solves all problems addressed here.

Exemplary embodiments of the present invention are described in greater detail below with reference to figures, which schematically show the following by way of example:

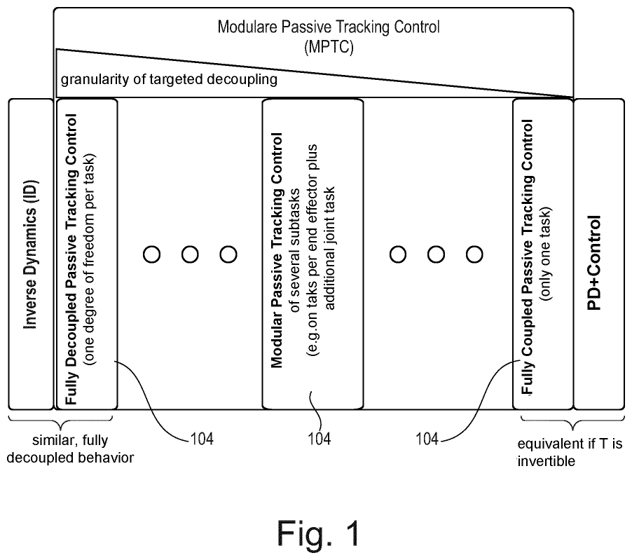

FIG. 1 shows that MPTC covers the complete range between inverse dynamics (ID) and PD+ control;

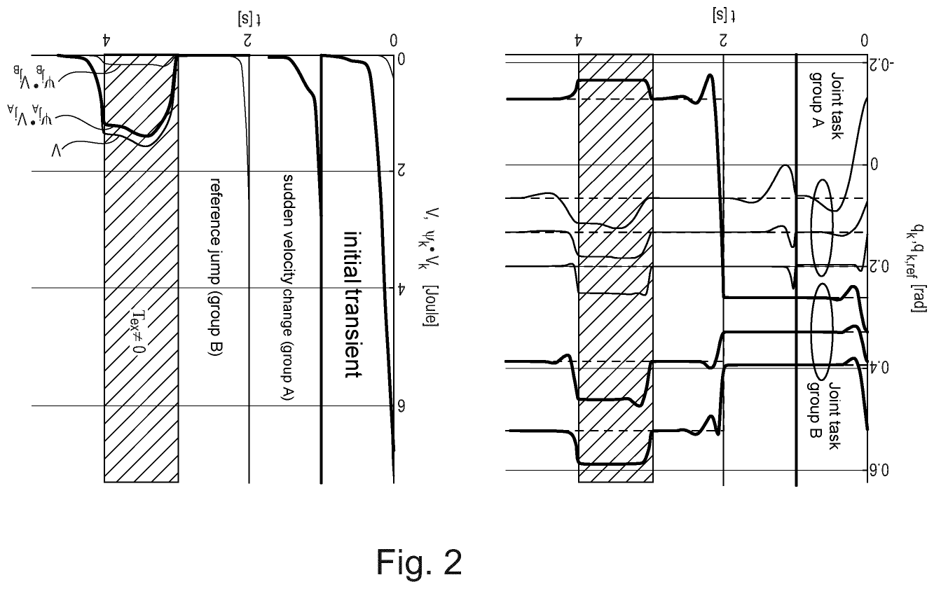

FIG. 2 shows transient responses for a fully determined and nonconflicting task setup. Left: joint angles and references. Right: overall and task-specific Lyapunov function values;

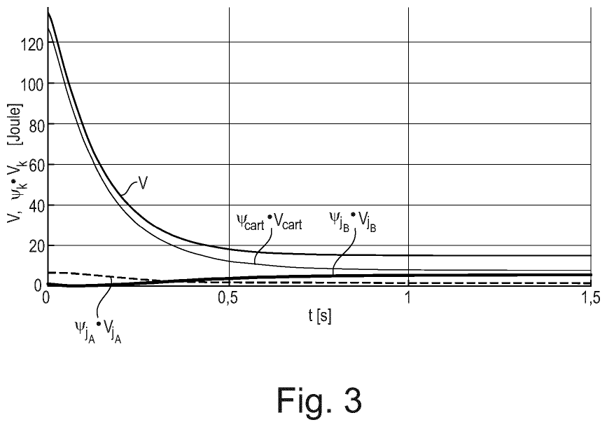

FIG. 3 shows transient response for an overdetermined (and thus conflicting) task setup;

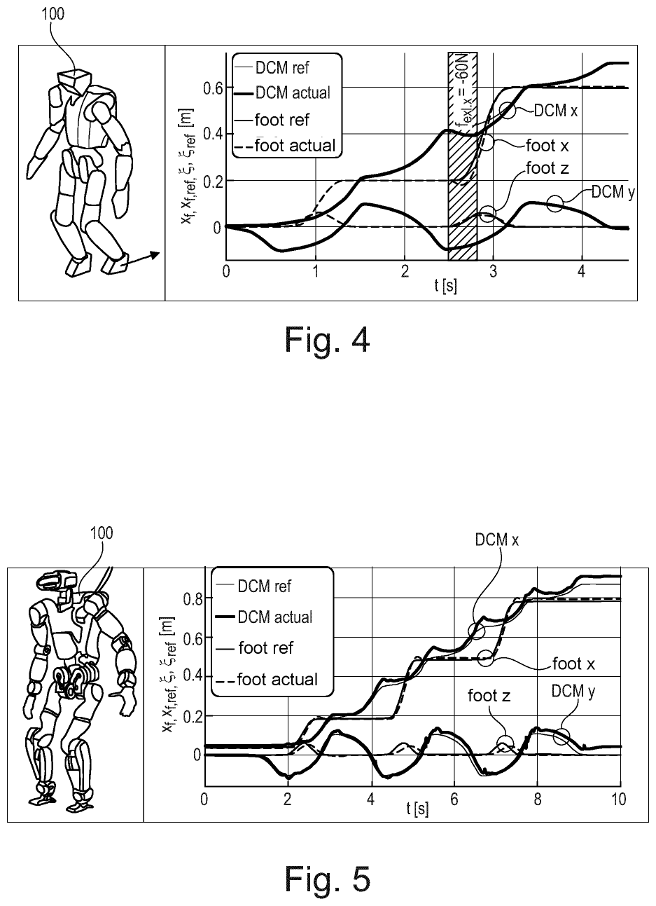

FIG. 4 shows a humanoid robot TORO walking in OpenHRP simulation (single and double support times: TSS=0.8 s, TDS=0.12 s). After 2.5 s, the left foot is perturbed by an external force of −60 N in the x direction for 0.3 s;

FIG. 5 shows TORO walking in an experiment (single and double support times: TSS=0.9 s, TDS=0.3 s, step length 0.15 m); and

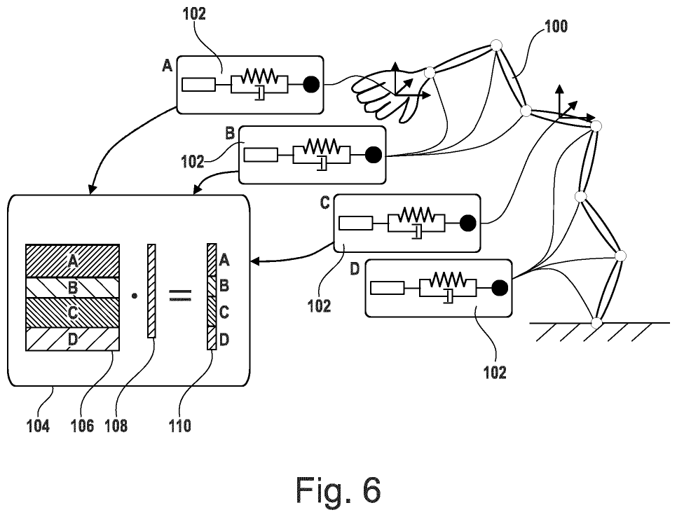

FIG. 6 shows one possible application of the method according to the present invention.

One embodiment of a modular passive tracking controller (MPTC) for “stack of tasks”-based controller-frameworks is described.

FIG. 6 shows an example of one possible application of the method according to the present invention. Multiple impedance-based controller modules 102 (modular passive tracking controllers) are integrated into an overall controller 104, using the method according to the present invention. In the example shown, the illustration of controller modules 102 in each case includes a reference trajectory and a mass that are connected to one another via a spring-damper system, controller modules 102 denoted by reference symbols A and C each representing a Cartesian control task, while controller modules 102 denoted by reference symbols B and D are formulated as joint controllers. As shown in FIG. 6, the various controller modules 102, each made up of a task mapping matrix and a task vector, may be combined to form a stack of tasks made up of a unified task mapping matrix 106 and a combined task vector 110. By use of a suitable optimization method, for example with the aid of optimization variables 108, the controller modules represented by the stack of tasks may be fused to form an overall controller 104. An optimal compromise between the various subcontroller objectives is thus achieved, in particular the passivity of resulting overall controller 104 being implemented in the best possible way.

The word “may” may refer in particular to optional features of the present invention. Consequently, there are also refinements and/or exemplary embodiments of the present invention which additionally or alternatively have the particular feature or the particular features.

If necessary, individual features may also be selected from the feature combinations disclosed above and used in combination with other features, with resolution of a structural and/or functional relationship possibly existing between the features, for delimiting the subject matter of the claims.

### LIST OF REFERENCE NUMERALS

100 robot
102 controller module
104 overall controller
106 task mapping matrix
108 optimization variables
110 task vector

1-30. (canceled)

31. A method for controlling a kinematically redundant robot in order to fulfill multiple tasks, comprising the steps of using at least one passivity-based first controller module, computing at least one task target description and at least one associated task mapping for the at least one first controller module, computing at least one weighting the tasks weighting in the form of a task-specific symmetrical matrix Wₖ=ψₖMₖ⁻¹, wherein the matrix Wₖ from the inverse of the task inertia matrix Mₖ, where Mₖ=(JₖM⁻¹JₖT)⁻¹, Jₖ is the task Jacobian and M is the inertia matrix of the dynamic model of the robot, and a weighting scalar ψₖ for independently weighting different tasks with respect to each other, and integrating the at least one first controller module into an overall controller, using the at least one task weighting matrix Wₖ which is combined in the form of sub-matrices into a symmetrical and block-diagonal overall weighting matrix W.

32. The method as recited in claim 30, wherein the at least one task target description and the at least one associated task mapping are computed in such a way that a nominal behavior of the at least one first controller module corresponds to the behavior of a mass-spring-damper system.

33. The method as recited in claim 30, wherein the at least one task target description and the at least one associated task mapping are computed based on a natural robot inertia.

34. The method as recited in claim 30, wherein the at least one task target description and the at least one associated task mapping are computed in such a way that task-specific Coriolis and centrifugal effects remain unchanged, while all other Coriolis and centrifugal effects are compensated for.

35. The method as recited in claim 30, wherein the at least one task target description is computed as a task vector, or the at least one associated task mapping is computed as a task mapping matrix.

36. The method as recited in claim 30, wherein at least one further controller module is integrated into the overall controller.

37. The method as recited in claim 30, wherein at least one further controller module formulated as a constraint is integrated into the overall controller.

38. The method as recited in claim 36, wherein the at least one further controller module is weighted.

39. The method as recited in claim 30, wherein the at least one first controller module or the at least one further controller module is weighted in such a way that the overall controller has an at least approximately passive behavior, even for an overdetermined control problem.

40. The method as recited in claim 30, wherein the at least one first controller module or the at least one further controller module is optimized with the aid of at least one pseudoinverse and/or at least one inverse.

41. The method as recited in claim 30, wherein the at least one first controller module and/or the at least one further controller module are/is quadratically optimized.

42. The method as recited in claim 30, wherein the first controller module is designed as a tracking controller.

43. The method as recited in claim 30, wherein the first controller module is designed as a regulation controller.

44. The method as recited in claim 30, wherein a separate controller module is assigned to each controllable degree of freedom.

45. A computer program product that includes commands which, when the program is executed with the aid of at least one processor, prompt the processor to carry out the method as recited in claim 30.
